(19) United States
(12) Patent Application Publication
(10) Pub. No.: US 2013/0019535 A1
(43) Pub. Date: Jan. 24, 2013

(54) D-Non Between Safety Guard for Hinged Doors

(71) Applicant: Charles Epps, Springfield, PA (US)

(72) Inventor: Charles Epps, Springfield, PA (US)

(21) Appl. No.: 13/549,327

(22) Filed: Jul. 13, 2012

Related U.S. Application Data
(60) Provisional application No. 61/572,364, filed on Jul. 13, 2011.

(51) Int. Cl. E06B 7/36

(52) U.S. Cl. 49/383

(57) ABSTRACT

The invention provides a protective device designed to fit over the open area of a doorway directly between the hinges and the edge of the door itself. The device is intended to be placed on both sides of the hinge. Fabricated of a malleable rubber or vinyl material, the present invention is an elongate cylindrically shaped unit designed to be snugly wedged in the open crack between the door and doorjamb. The device compresses when the door is opened regains its original shape when the door is closed.

### CLAIM OF PRIORITY

This patent application claims priority under 35 USC 119 (e) (1) from U.S Provisional Patent Application Ser. No. 61/572,364 filed Jal. 13, 2011, of common inventorship herewith entitled, “D-Non-Between.”

### FIELD OF THE INVENTION

The present invention pertains to the field of aftermarket door accessories, and more specifically to the field of safety guards for hinged doors.

### BACKGROUND OF THE INVENTION

The prior art has put forth several designs for safety guards for hinged doors. Among these are:

U.S. Pat. No. 7,234,202 to Kai Yip Li describes a semi automatic finger protection device which comprises a bumper positioned between an outer surface of the door and a doorpost when the door is closed, and positioned in gap when the door is opened. The bumper comprises a securing member and a connecting member. A flexible wrapping means is received in the bumper to extend and retract the connecting member.

U.S. Pat. No. 6,141,909 to Brian R. Hanson describes a protective shield for attachment to the door and door jamb for covering a pinch void area and preventing fingers being pinched in the area. The unique geometry of the shield and narrow attachment allows for easy installations on door assemblies with push bars or panic devices.

U.S. Pat. No. 5,001,862 to Abraham Albenda describes a finger, hand and body part protector for hinged doors comprising an aesthetically pleasing foldable protective member. The protector is is formed like an accordion in the shape of a recoiling tube and extends over at least a portion of the height of the face opening or gap of a hinged door.

None of these prior art references describe the present invention.

### SUMMARY OF THE INVENTION

It is an object of the present invention to provide a safety guard for hinged doors.

### BRIEF DESCRIPTION OF THE DRAWINGS

FIG. 1 is an illustrative view of a hinged door without the present invention.

FIG. 2 is an illustrative view of a hinged door with the present invention attached to it.

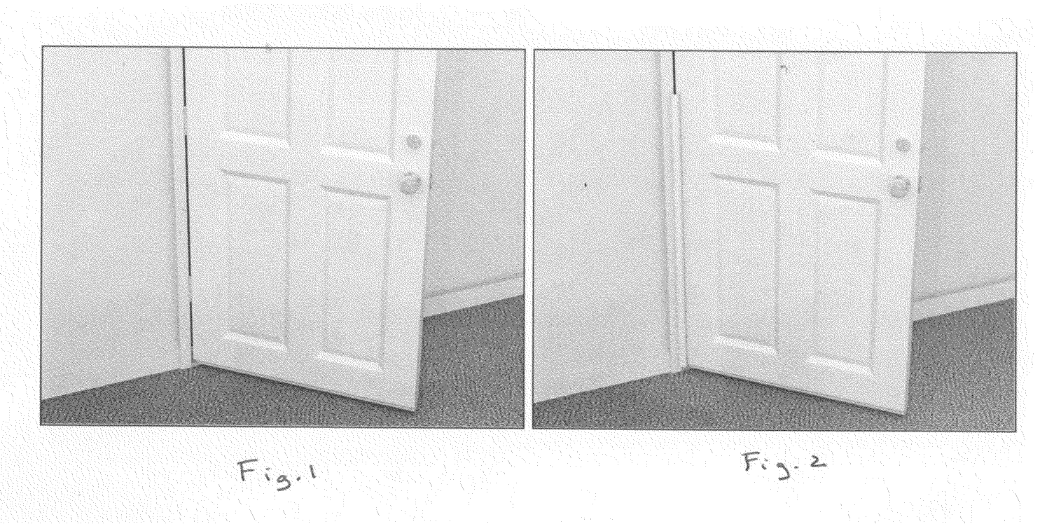

### DETAILED DESCRIPTION OF THE INVENTION

Many injuries occur in homes among curious children touching an electrical outlet or a hot stovetop or oven. Parents conscientiously childproof their home to avoid accidental injuries, but often overlook open cracks between hinge areas of a doorway where the door connects to the frame. This area seems to be a magnet for curious little fingers. A moving door causes painful pinching of children's small digits and may result in broken fingers.

The present invention, hereinafter referred to as the D-Non Between, is a protective device designed to fit over the open area of a doorway directly between the hinges and the edge of the door itself. The device is intended to be placed on both sides of the hinge. Fabricated of a malleable rubber or vinyl material, the present invention is an elongate cylindrically shaped unit designed to be snugly wedged in the open crack between the door and doorjamb. The device compresses when the door is opened regains its original shape when the door is closed. The elongated D-Non Between fits standard household doorways and is held in place with a tension fit.

Alternate embodiments of the D-Non Between comprise evenly spaced holes for nailing the unit to the doorjamb or a heavy duty adhesive material for secure attachment.

Use and application of the D-Non Between is very simple and straightforward. For maximum protection, the parent purchases enough units to accommodate both sides of every doorway in the house. From the side of the door that opens inward, the user places two of the D-Non Betweens flush against each side of the hinge in the jamb, completely covering both sides of the crack between the door and the frame. Following package instructions, the user nails the unit to the frame or attaches it to the hinged surface of the door jamb by means of adhesive. The D-Non Between works as a shield between the door and jamb, preventing children from inserting fingers into the formerly open space. Efficiently blocking the hinge area of the door, the D-Non Between eliminates the pinching hazard inherent in common household doorways. The flexible rubber material provides sufficient coverage of the open area without hindering the operation of the door. The D-Non Between is an invaluable preventive aid for households, day care centers, nursery schools and preschools.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

Claims:

1. A safety guard for a hinged door, comprising: an elongate tubular cylindrical device comprised compressible material to fit between a door jamb and a door on the hinged side of the door.

2. The safety guard for a hinged door of claim 1 wherein the device is made of malleable rubber.

3. The safety guard for a hinged door of claim 1 wherein the device is made of vinyl.

4. The safety guard for a hinged door of claim 1 wherein the device is placed on both sides of the hinge.

5. The safety guard for a hinged door of claim 1 wherein the device is held in place with a tension fit.

6. The safety guard for a hinged door of claim 1 wherein the.device further comprises evenly spaced holes for nailing the unit to the door jamb.

7. The safety guard for a hinged door of claim 1 wherein the device further comprises an adhesive material for secure attachment.
